(19) United States
(12) Patent Application Publication
(10) Pub. No.: US 2006/0133393 A1
(43) Pub. Date: Jun. 22, 2006

(54) Aging processing apparatus and method in communications system

(75) Inventor: Ji-Wook Yun, Gyunggi-Do (KR)

Correspondence Address: FLESHNER & KIM, LLP, P.O. BOX 221200, CHANTILLY, VA, 20153, US

(73) Assignee: LG-Nortel Co., Ltd.

(21) Appl. No.: 11/292,144

(22) Filed: Dec. 2, 2005

(30) Foreign Application Priority Data
Dec. 6, 2004 (KR) KR101715/2004

(51) Int. Cl. H04L 12/56; H04L 12/28

(52) U.S. Cl. 370/401

(57) ABSTRACT

An aging processing apparatus and method of a Gateway GPRS Support Node (GGSN) in a Universal Mobile Telecommunications System (UMTS), wherein the GGSN determines an appropriate aging policy on the basis of aging environmental information set by a manager, and checks whether a traffic is generated in every session or a session set by a particular APN for a reference time according to the determined aging policy, thereby performing managing (searching and releasing) with respect to abnormal sessions in which only a call connection is maintained without any packet flow.

### BACKGROUND OF THE INVENTION

1. Field of the Invention

The present invention relates to a Universal Telecommunications System (UMTS), and particularly, to an aging processing apparatus and method in a Gateway GPRS Node (GGSN) node.

2. Background of the Related Art

In general, a UMTS is a third generation mobile communications system that evolved from the European Global System for Mobile Communications (GSM) system, and aims to provide a more improved mobile communications service on the basis of GSM Core Network and Wideband Code Division Multiple Access (WCDMA) technology.

FIG. 1 is a view illustrating a network structure of a typical UMTS system.

As illustrated in FIG. 1, the UMTS system may roughly comprise a terminal, a UTRAN and a Core Network (CN). The UTRAN may include one or more Radio Network Sub-systems (RNSs), each of which includes one Radio Network Controller (RNC) and one or more Nodes B (i.e., base stations) managed by the RNC.

Each RNC is connected to a Mobile Switching Center (MSC) of the CN for circuit switching communications with a GSM network, and simultaneously connected to a Serving General Packet Radio Service (GPRS) Support Node (SGSN) for packet switching communications with a GPRS network. Also, the SGSN is connected to a Packet Data Network (PDN) via a Gateway GPRS Support Node (GGSN). At this time, the SGSN is connected to the GGSN via a Gn interface, and the GGSN is connected to the PDN via a Gi interface.

The SGSN performs positioning (tracing of location) and access control of a terminal, and is connected to a Hole Location Register (HLR) of the GSM to perform authentication with respect to the terminal. In this case, the SGSN manages the location of the terminal using a Routing Area (RA).

The GGSN, which is a node to perform a gateway function for a data service with other packet networks, determines to which SGSN data is to be sent when the data is received from the PDN. The GGSN actually performs a function of transmitting data to the SGSN using a GPRS tunneling Protocol (GTP). That is, the GGSN basically operates as a Internet Protocol (IP) router for performing a routing function.

The GGSN converts a GPRS packet transmitted from the SGSN into appropriate types of Packet Data Protocol (PDP) (e.g., IP, X.25, etc) for transmission. The GGSN also has a function for converting a PDP address of a received packet data into a GSM address of a receiver. In addition, the GGSN stores an address of the SGSN of a user who is currently positioning in a location register of the SGSN and a user profile, and performs an authentication and a accounting (charging) function.

However, in the related art, there is not any recommendation with respect to processing of an access call management (referred to as ‘Aging’ hereafter) function. Accordingly, when a mobile subscriber connects to the GGSN to receive a packet service, the GGSN performs a function as a gateway for providing the packet service to the subscriber. At this time, there may occur cases in which information for the connected subscriber is abnormally maintained (positioned) only in the GGSN among several nodes of the UMTS, or only a call connection is maintained without any packet flow, and thus a particular function of managing (searching, and releasing) of these sessions is required.

### BRIEF DESCRIPTION OF THE INVENTION

Therefore, an object of the present invention is to provide an aging processing apparatus and method in a mobile communications system capable of managing the aging of a mobile subscriber connected to a UMTS network in order to receive a packet service.

To achieve these and other advantages and in accordance with the purpose of the present invention, as embodied and broadly described herein, there is provided an aging processing apparatus in a communications system comprising: a manager for setting aging environmental information; and a GGSN for checking a generation of a traffic in at least one or more sessions for a reference time on the basis of the set aging environmental information, and releasing the connection of abnormal sessions.

Preferably, the aging environmental information is set using at least one or more of an application range, a procedure type and the reference time.

Preferably, the application range is set as every session or as an APN unit, the procedure type is set as automatic or as manual, and the reference time is set as a minute unit.

Preferably, the GGSN determines an aging policy on the basis of the set aging environmental information, checks whether a traffic is generated in a particular session for the reference time according to the determined aging policy, and manages the connection of each abnormal session.

Preferably, the aging policy is determined depending on one of every session/automatic/reference time, every session/manual/reference time, APN unit/automatic/reference time, and APN unit/manual/reference time.

Preferably, the GGSN may include: a System Management Processor (SMP) for managing aging environmental information inputted by the manager; a Gn interface card for transferring a subscriber's call establishment request inputted from a radio communications network; a Gateway Control Processor (GCP) for performing a call establishment according to the subscriber's call establishment request and session connection/release (disconnection), and reading a reference time from the aging environmental information to output the read reference time; a packet handler card for checking whether a traffic is generated in a particular session for the reference time provided from the GCP, to thus request a releasing of the corresponding session from the GCP when it is checked that the traffic is not generated; and a Gi interface card for transferring the traffic between the packet handler card and a packet data network.

Preferably, the particular session refers to a session of every mobile subscriber connected to the GGSN or a session requested to be set as the APN.

According to another embodiment of the present invention, there is provided an aging processing method in a communications system comprising: setting, by a manager, aging environmental information in a Gateway GPRS Support Node (GGSN) using a Man Machine Interface (MMI); determining, by the GGSN, an aging policy on the basis of the set aging environmental information; checking, by the GGSN, whether a traffic is generated in a particular session for a reference time according to the determined aging policy, to thus manage the connection of abnormal sessions.

The aging environmental information is set using at least one or more of an application range, a procedure type and the reference time.

Preferably, the application range is set as every session or as an APN unit, the procedure type is set as automatic or as manual, and the reference time is set as a minute unit.

Preferably, when the traffic is not generated in particular sessions for the reference time, the GGSN automatically or manually releases the connection of the corresponding sessions.

Preferably, the particular session is included in the aging policy, and refers to every session or a session set by the APN.

Preferably, the determining of the aging policy may include: reading the aging environmental information from a global aging database (DB) to determine an application range of the aging processing; reading a procedure type and a reference time from the global aging DB when the application range of the aging processing is set as the every session, while reading the procedure type and the reference time from an APN DB when the application range is set as the APN unit; and determining the aging policy on the basis of the read application range, the procedure type and the reference time.

Preferably, the aging policy is determined as types of every session/automatic/reference time, every session/manual/reference time, APN unit/automatic/reference time, and APN unit/manual/reference time.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a network structure of a typical UMTS system;

FIG. 2 illustrates a construction of an aging apparatus in a communications system in accordance with an embodiment of the present invention;

FIG. 3 is a flowchart illustrating sequential steps of an aging processing method in a communications system in accordance with an embodiment of the present invention;

FIG. 4 is a flowchart illustrating sequential steps of performing an aging function by the GGSN according to aging environmental information;

FIG. 5 illustrates a screen for setting aging environmental information in accordance with a first embodiment of the present invention;

FIG. 6 illustrates a screen for setting the aging environmental information in accordance with a second embodiment of the present invention;

FIG. 7 illustrates a screen for setting the aging environmental information in accordance with a third embodiment of the present invention;

FIG. 8 illustrates a screen for setting the aging environmental information in accordance with a fourth embodiment of the present invention; and

FIG. 9 illustrates a screen for setting the aging environmental information in accordance with a fifth embodiment of the present invention.

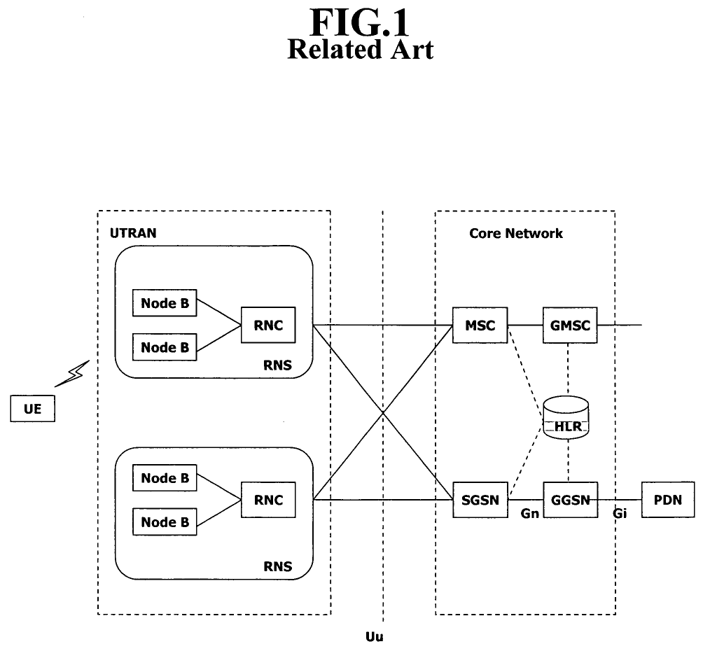

### DETAILED DESCRIPTION OF THE INVENTION

Reference will now be made in detail to the preferred embodiments of the present invention, examples of which are illustrated in the accompanying drawings.

The present invention provides a method for managing (searching and releasing) corresponding sessions effectively when information related to a connected subscriber is abnormally maintained (positioned) only in a GGSN or only a call connection is maintained without any packet flow.

In general, the GGSN must perform managing (searching and releasing) of connections of abnormal sessions in which a packet is not transmitted for a long time. Such processing function of the GGSN is defined as an aging function in the present invention. Upon performing the aging, the GGSN provides a function such that the corresponding session can automatically be released based on a procedure type set by a manager, or can manually be released by a manager's searching for the corresponding session.

The present invention defines aging environmental information (i.e., a processing condition) to process the aging function as follows.
Application range: every session/APN unit
Procedure type: automatic/manual
Reference time: a time for which a traffic is not generated (unit: minute)

The aging environmental information is stored in a global aging Database (DB) of the GGSN. The GGSN refers to the procedure type and the reference time in the corresponding DB when the application range is set as the every session, while creating a referential environment DB in order to store and refer to the procedure type and the reference time as an Access Point Name (APN) unit when the application range is set as the APN unit.

Therefore, in the present invention, the aging function may include four types of aging policies (every/automatic/reference time, every/manual/reference time, APN/automatic/reference time, and APN/manual/reference time) on the of the aging environmental information. The procedure according to each determined policy will now be explained.

First, when the aging policy is set as the every/automatic/reference time, if a traffic is not generated in every set session for the reference time, the GGSN automatically performs a procedure for releasing the connection of the corresponding sessions.

Second, when the aging policy is set as the every/manual/reference time, if the traffic is not generated in every set session for the reference time, the GGSN records in information related to the corresponding subscriber that the subscriber is an object to be manually managed for his call connection. Accordingly, the system manager searches for the corresponding session according to an aging object searching command to manually perform the connection release with respect to the corresponding session.

Third, when the application range of the aging policy is set as the APN unit, the GGSN refers to procedure type/reference time which is set for the session requested to be set from the APN DB. Upon setting the processing condition as automatic/reference time, if the traffic is not generated for the reference time, the GGSN automatically performs the procedure for releasing the connection of the corresponding session.

Fourth, in this type, the application range is set as the APN unit, and the processing condition is set as manual/reference time with reference to procedure type/reference time with respect to a session requested to be set in the APN DB. Upon setting the processing condition as manual/reference time, if the traffic is not generated in every set session for the reference time, the GGSN records in information related to the corresponding subscriber that the subscriber is an object to be manually managed for his call connection. Accordingly, the system manager searches the corresponding session according to an aging object searching command to manually perform the connection release with respect to the corresponding session.

An internal procedure of the GGSN with respect to each aging policy will now be explained in more detail.

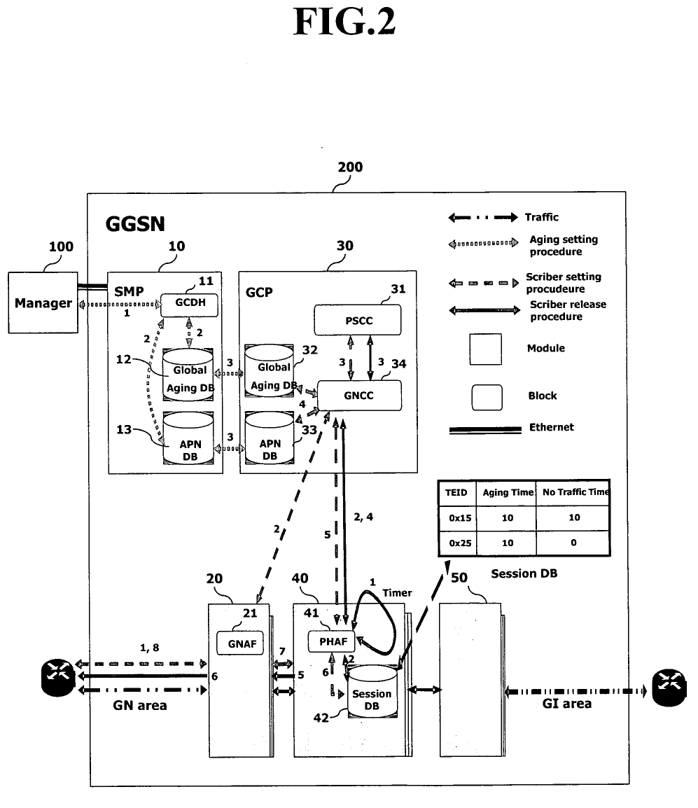

FIG. 2 illustrates a construction of an aging processing apparatus in a communications system in accordance with an embodiment of the present invention.

As illustrated in FIG. 2, an aging processing apparatus in a communications system according to the present invention may include: a manager 100 for setting aging environmental information; and a GGSN 200 for checking a generation of a traffic in a particular session for a reference time on the basis of the set aging environmental information to perform a managing of abnormal sessions. Preferably, the particular session indicates every session or a session requested to be set from the APN (set by the APN).

The GGSN 200 may include: a System Management Processor (SMP) 10 for managing the aging environmental information inputted by the manager 100; a Gn interface card 20 for transferring a subscriber's call establishment request inputted through a radio communications network; a Gateway Control Processor (GCP) 30 for setting the corresponding call according to the call establishment request inputted via the Gn interface card 20, and outputting a reference time for a traffic processing from the aging environmental information inputted by the manager 100; a packet handler card 40 for checking whether the traffic is generated for the reference time provided from the GCP 30, and requesting a session release from the GCP 30 when the traffic is not generated; and a Gi interface card 50 for transferring the traffic between the packet handler card 40 and the PDN.

The SMP 10 may include: a Gateway Control Data Handler (GCDH) 11 for receiving the aging environmental information set by the manager 100; a global aging DB for selectively storing the aging environmental information received at the GCDH 11 according to the application range set by the manager 100; and an APN DB 13.

The GCP 30 may include: a packet Data Protocol (PDP) Context & Session Management Connection Control (PSCC) 31 for performing managing of the PDP contexts and setting/releasing of sessions; a global aging DB 32 and an APN DB 33 in which data are synchronized with those in the global aging DB 12 and the APN DB 13, respectively; and a Gn Interface Connection Control (GNCC) 34 for requesting session setup and session release from the PSCC 31 according to the subscriber's call establishment request inputted through the Gn interface card 20 or the session release request from the packet handler card 40, and reading a reference time for the traffic processing from the global aging DB 32 or the APN DB 33 and outputting the read reference time to the Gi interface card 40.

The Gn interface card 20 transfers the subscriber's call establishment request inputted through the radio communications network to the GCP 30, and performs a function of transferring the traffic inputted from a Packet Data Network (PDN) via the Gi interface card 50 and the packet handler card 40. At this time, the subscriber's call establishment request is performed by a Gn Interface Adaptation Function (GNAF) 21.

The packet handler card 40 may include a Packet Handler Adaptation Function (PHAF) 41 for checking whether the traffic is generated for the reference time received from the GCP 30, and requesting a session release from the GCP 30 if the traffic is not generated, and a session DB 42 for storing the reference time received from the GCP 30. Reference numerals 1 to 8 denote sequences of the call establishment and the aging procedure.

An operation of the aging processing apparatus in the communications system according to an embodiment of the present invention having such construction will now be explained.

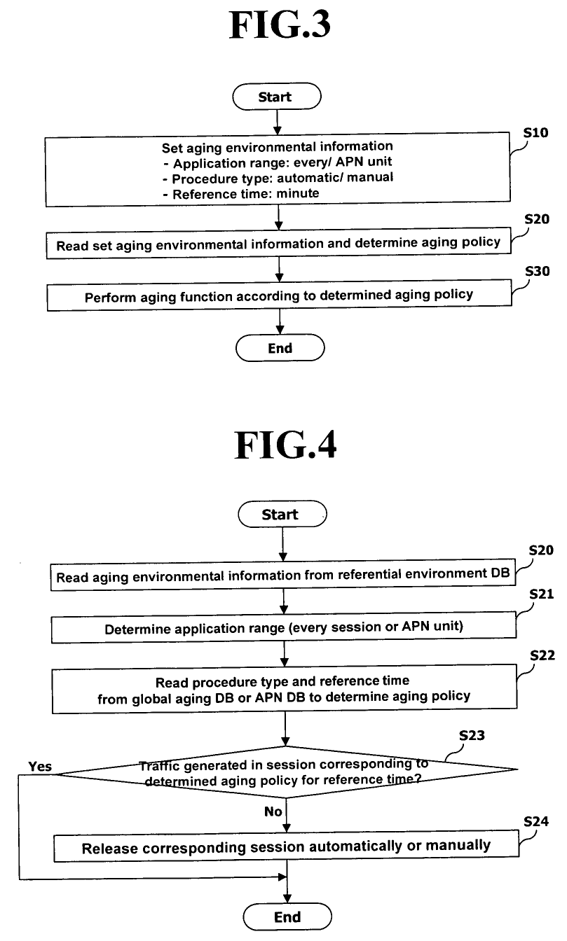

FIG. 3 is a flowchart illustrating sequential steps of an aging processing method in a communications system in accordance with an embodiment of the present invention.

As illustrated in FIG. 3, an aging processing method in a communications system according to the present invention may comprise: setting aging environmental information in a referential environment DB of the GGSN by the manager 100 (S10); determining an aging policy, by the GGSN, on the basis of the set aging environmental information (S20); and performing an aging function, by the GGSN, according to the determined aging policy (S30).

The aging environmental information is set using one or more of an application range, a procedure type and a reference time. At this time, the application range is set as every session/APN unit, the procedure type is set as automatic/manual, and the reference time is usually set as a minute unit which indicates a time for which a traffic is not generated.

The aging policy may be classified into every session/automatic/reference time, every session/manual/reference time, APN unit/automatic/reference time, and APN unit/manual/reference time.

In order to perform the step S10, the manager 100 inputs the application range (every/APN unit) of the aging environment using a Man machine Interface (MMI) command. When the application range is inputted as ‘every’, the manager 100 inputs the procedure type (automatic/manual) and the reference time, and the inputted aging environmental information is all stored in the global aging DB 12 by the GCDH 11 of the SMP 10.

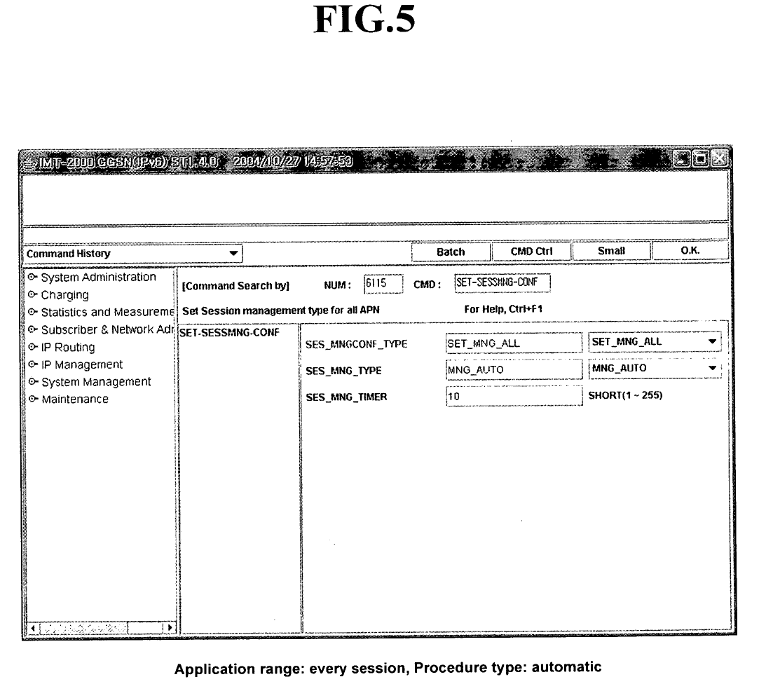

Conversely, when the manager 100 inputs the application range as ‘APN unit’, the GCDH 11 stores only the information related to the application range in the global aging DB 12, and stores the information related to the procedure type and the reference time in the APN DB 13. When the manager 100 does not separately set the aging environmental information, a default aging environment is set as APN unit/automatic/60-minute. FIGS. 5 to 9 illustrate various embodiments for setting the aging environmental information in the GGSN 200.

Aging environment DB values set in the referential environment DB of the SMP 10, namely, the global aging DB 12 and the APN DB 13 are synchronized at the GCP 30 in which the call processing is performed and an Operating System (OS) level. That is, the environment DB values set in the global aging DB 12 and the APN DB 13 are synchronized with those in the global aging DB 32 and the APN DB 33, respectively, for storing.

Also, upon receiving the call establishment request message from the radio communications network via the Gn interface, the GNAF 21 transfers the subscriber's call establishment to the GNCC 34 of the GCP 30. The GNCC 34 analyzes a GTP protocol to request accounting initialization and IP to be allocated to a terminal together with the call establishment from the PSCC 31.

By undergoing such processes, when the manager 100 sets the aging environmental information, the GGSN 200, as illustrated in the steps S20 and S30, reads the aging environmental information from the referential environment DB to determine the aging policy. The GGSN 200 then performs the aging function according to the determined aging policy so as to execute a managing of abnormal sessions.

The determining of the aging policy by GGSN 200 may include; reading the aging environmental information from the global aging DB to determine the application range; reading the procedure type and the reference time from the global aging DB when the application range is set as the every session, while reading the procedure type and the reference time from the APN DB when the application range is set as the APN unit; and determining the aging policy depending on the read application range, the procedure type and the reference time.

FIG. 4 is a flowchart illustrating a step of performing the aging function by the GGSN depending on the aging environmental information.

As illustrated in FIG. 4, the GGSN 200 reads the aging environmental information from the referential environment DB to determine the aging policy (S20). Then, the GGSN 200 determines the application range of the aging environmental information (S21). Upon determining the application range, the GGSN 200 reads the procedure type and the reference time from the global aging DB 32 or the APN DB 33 to determine the aging policy (S22). The GGSN 200 then checks whether a traffic is generated in a session corresponding to the determined aging policy for the reference time (S23). When it is checked that the traffic is not generated, the GGSN 200 releases the connection of the corresponding session (S24). Preferably, the connection of the session is released automatically or manually with reference to the procedure type.

That is, the GNCC 34 of the GGSN 200 reads the aging environmental information from the global aging DB to check whether the application range has been set as every session unit or the APN unit. If it is checked that the application range is set as the every session, the GNCC 34 of the GGSN 200 reads the reference time from the global aging DB 32, while reading the reference time from the APN DB 33 when the application range is set as the APN unit. Accordingly, the GNCC 34 of the GGSN 30 transfers the read reference time to a Packet Handler (PH) block of the packet handler card 40, namely, the PHAF 41.

The PHAF 41 stores the reference time received from the GNCC 34 in an aging time field of the session DB 42, and drives an one-minute timer. The PHAF 41 increases a ‘No Traffic Time Value’ by one whenever the timer expires. If the traffic is generated while the timer is driven, the PHAF 41 initializes the corresponding field value into ‘0’. Afterwards, when the ‘No traffic time’ is identical to the aging time (i.e., the reference time), the PHAF 41 considers as the traffic is not generated for the reference time, and requests the session release from the GNCC 34.

FIG. 5 shows a screen for setting the aging environmental information in accordance with a first embodiment. In the drawing, the application range is set as ‘every session’, the procedure type is set as ‘automatic’, and the reference time is set as ‘ten-minute’. In this case, the GGSN 200 searches for sessions of all the mobile subscribers who want to receive a packet service, to check whether a traffic is generated for the reference time (ten-minute). If it is checked that the traffic is not generated for the reference time (ten-minute) in particular sessions, the GGSN 200 automatically releases the connections of the corresponding particular sessions.

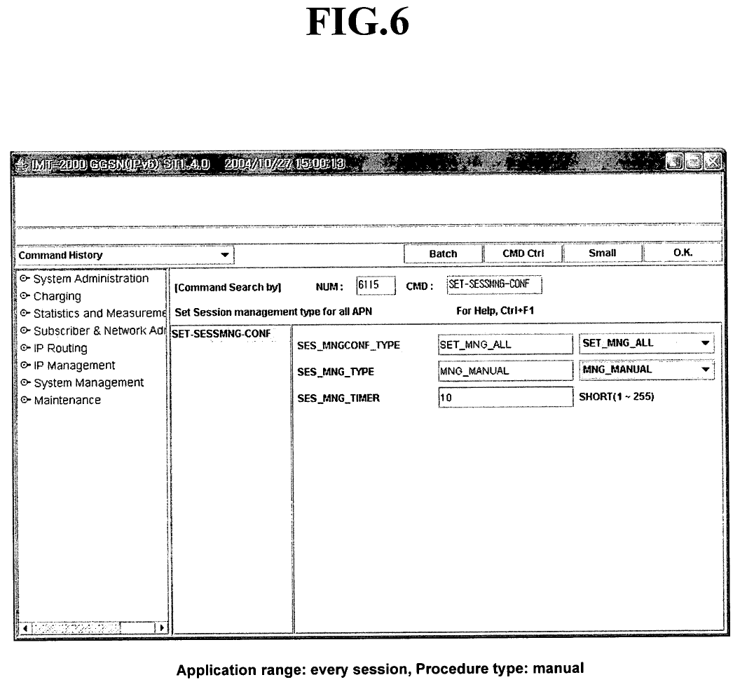

FIG. 6 shows a screen for setting the aging environmental information in accordance with a second embodiment, in which the application range is set as

‘every session’, the procedure type is sets as ‘manual’, and the reference time is set as ‘ten-minute’. In this case, the GGSN 200 checks whether the traffic is generated in sessions of all the mobile subscribers who want to receive the packet service for the reference time (ten-minute). When the traffic is not generated therein for the reference time (ten-minute), the GGSN 200 records in subscriber information that the subscriber is an object to be manually managed for his call connection. Accordingly, the system manager 100 searches for a session in which the traffic is not generated using an aging object searching command, so as to manually release the connection of the corresponding session.

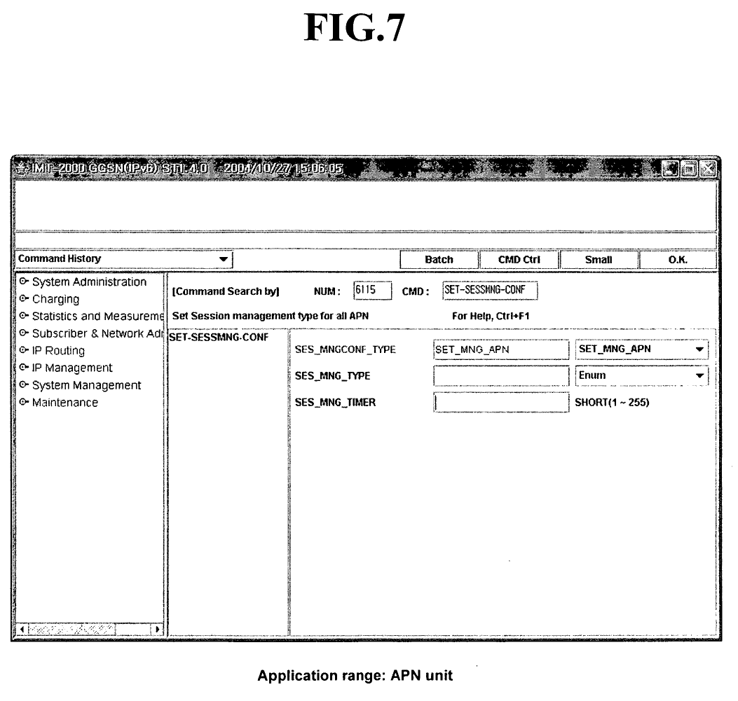

FIG. 7 illustrates a screen for setting the aging environmental information in accordance with a third embodiment, in which the application range is set as ‘APN unit’. In this case, the GGSN 200 refers to the aging environmental information recorded in the APN DB, namely, the procedure type and the reference time.

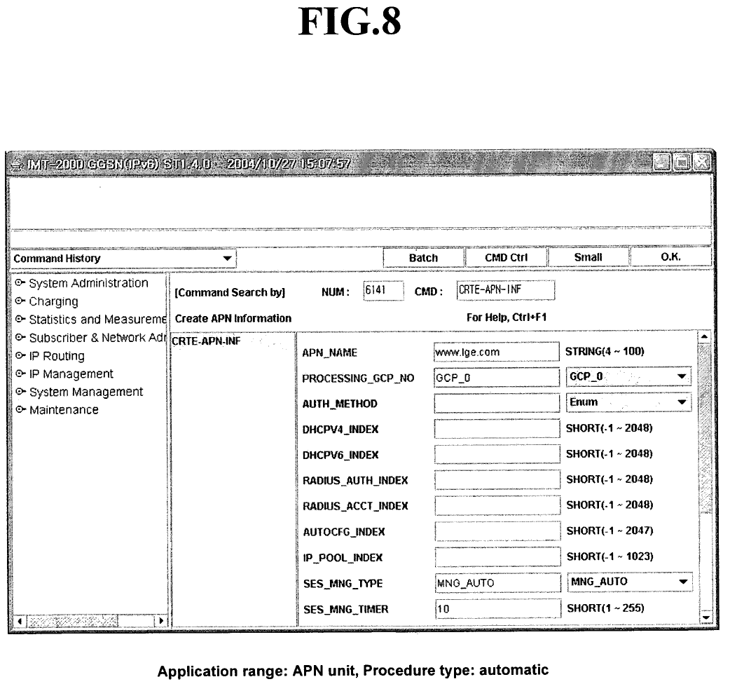

FIG. 8 shows a screen for setting the aging environmental information in accordance with a fourth embodiment, in which the application range of the aging environmental information is set as ‘APN unit’, the procedure type is set as ‘automatic’, and the reference time is set as ‘ten-minute’. In this case, the GGSN 200 checks whether the traffic is generated in the session requested to be set from the APN for the reference time (ten-minute). If the traffic is not generated for the reference time (ten-minute), the GGSN 200 automatically releases the connection of the corresponding session.

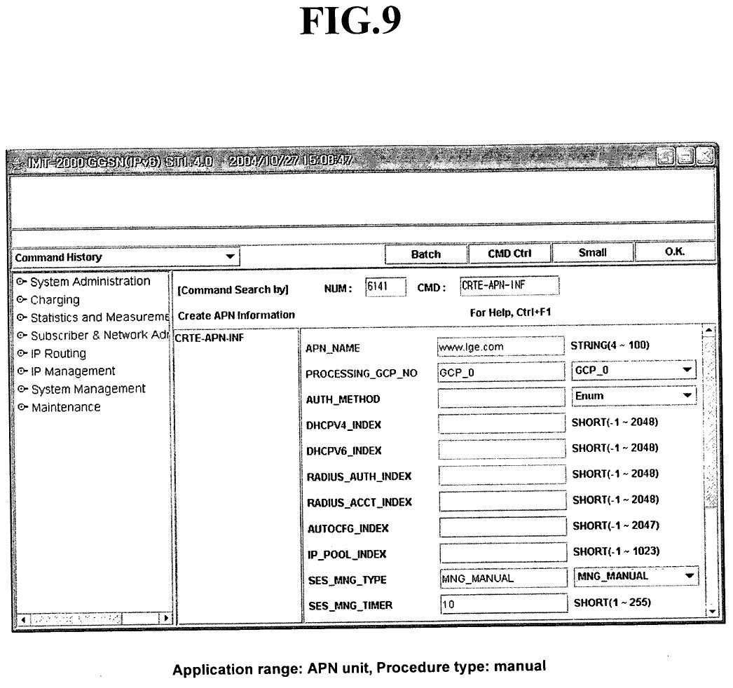

FIG. 9 is a fifth embodiment of a screen for setting the aging environmental information, in which the application range of the aging environmental information is set as ‘APN unit’, the procedure type is set as ‘manual’, and the reference time is set as ‘ten-minute’. In this case, the GGSN 200 checks whether the traffic is generated in the session requested to be set from the APN for the reference time (ten-minute). If the traffic is not generated for the reference time (ten-minute), the GGSN 200 records in subscriber information that the subscriber is an object to be managed for his call connection. Accordingly, the system manager 100 searches for a session in which the traffic is not generated using an aging object searching command, so as to manually release the connection of the corresponding session.

As described above, in the present invention, after setting the aging environmental information in the referential environment DB of the GGSN, the GGSN performs the aging function according to the set aging environmental information, and accordingly it is effective to manage (search and release) the case in which information related to the connected subscriber is only maintained (positioned) only in the GGSN, or it is more effective to manage (search and release) the sessions in which only the call connection is maintained without any packet flow.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An aging processing apparatus in a mobile communications system comprising:
a manager for setting aging environmental information; and
a Gateway GPRS Support Node (GGSN) for checking whether a traffic is generated in at least one or more sessions for a reference time on the basis of the aging environmental information set by the manager, and thus releasing a connection of each abnormal session.

2. The apparatus of claim 1, wherein the aging environmental information is set using at least one or more of an application range, a procedure type and a reference time.

3. The apparatus of claim 2, wherein the application range is set as every session or as an APN unit, the procedure type is set as automatic or manual, and the reference time is set as a minute unit.

4. The apparatus of claim 1, wherein the GGSN includes:
a System Management Processor for managing the aging environmental information inputted by the manager;
a Gn interface card for transferring a subscriber's call establishment request inputted from a radio communications network;
a Gateway control Processor (GCP) for performing the call establishment according to the subscriber's call establishment request and session connection and session release, and reading a reference time from the aging environmental information for outputting;
a packet handler card for checking whether a traffic is generated in a particular session for the reference time provided from the GCP, and requesting a release of the corresponding session from the GCP when the traffic is not generated; and
a Gi interface card for transferring the traffic between the packet handler card and a packet data network.

5. The apparatus of claim 4, wherein the particular session indicates a session of all the mobile subscribers connected to the GGSN or a session requested to be set from the APN.

6. The apparatus of claim 4, wherein the SMP includes:
a Gateway Control Data Handler (GCDH) for receiving the aging environmental information; and
a first global aging Database (DB) and a first APN DB for selectively storing the aging environmental information received at the GCDH according to the application range of the aging environmental information.

7. The apparatus of claim 4, wherein the GCP includes:
a Packet Data Protocol (PDP) Context & Session Management Connection Control (PSCC) for performing managing of the PDP context and setting and releasing of a session;
a second global aging DB and a second APN DB in which data are synchronized with data in the first global aging DB and the first APN DB of the SMP; and
a Gn Interface Connection Control (GNCC) for processing the subscriber's call establishment request, requesting setting or releasing of the session from the PSCC, and reading the reference time from the second global aging DB or the second APN DB to output the reference time to the packet handler card.

8. The apparatus of claim 4, wherein the Gn interface card includes a Gn Interface Adaptation Function (GNAF) for transferring the subscriber's call establishment request inputted via the radio communications network, and transferring the traffic to be transferred via the Gi interface card to the radio communications network.

9. The apparatus of claim 4, wherein the Gi interface card includes:
a Packet Handler Adaptation Function (PHAF) for checking whether a traffic is generated for the reference time, to request a session release from the GCP when the traffic is not generated; and
a session DB for storing the reference time transferred via the PHAF.

10. An aging processing method in mobile communications system comprising:
setting, by a manager, aging environmental information in a Gateway GPRS Support Node (GGSN) using a Man Machine Interface (MMI) command;
determining, by the GGSN, an aging policy on the basis of the set aging environmental information; and
checking, by the GGSN, whether a traffic is generated in particular sessions for a reference time according to the determined aging policy, to thus manage a connection of abnormal sessions.

11. The method of claim 10, wherein the aging environmental information is set using one or more of an application range, a procedure type and a reference time.

12. The method of claim 10, wherein the application range is set as every session or as an APN unit, the procedure type is set as automatic or manual, and the reference time is set as a minute unit.

13. The method of claim 10, wherein the GGSN automatically or manually releases the connections of the particular sessions when the traffic is not generated in the corresponding particular sessions.

14. The method of claim 10, wherein the particular session is a session included in the aging policy, and indicates every session or a session set by the APN.

15. The method of claim 10, wherein the determining of the aging policy includes:
reading the aging environmental information from a global aging Db to determine an application range of an aging processing;
reading a procedure type and a reference time from the global aging DB when the application range of the aging processing is set as every session, while reading the procedure type and the reference time from an APN DB when the application range is set as APN unit; and
determining the aging policy on the basis of the read application range, the procedure type and the reference time.

16. The method of claim 15, wherein the aging policy is determined as a type of every session/automatic/reference time, every session/manual/reference time, APN unit/automatic/reference time, and APN unit/manual/reference time.

17. The method of claim 10, wherein the managing of the traffic includes:
when the aging policy is determined as every session/automatic/reference time, checking whether a traffic is generated in every session for the reference time; and
when the traffic is not generated for the reference time, automatically releasing the corresponding sessions.

18. The method of claim 10, wherein the managing of the traffic includes:
when the aging policy is determined as every session/manual/reference time, checking whether a traffic is generated in every session for a reference time;
when the traffic is not generated for the reference time, recording in subscriber information that the subscriber is an object to be manually managed for his call connection; and
searching, by the manager, for the corresponding session using an aging object searching command, to thus manually release the connection of the corresponding session.

19. The method of claim 10, wherein the managing of the traffic includes:
when the aging policy is determined as APN unit/automatic/reference time, checking whether a traffic is generated in a session set by the APN for a reference time; and
when the traffic is not generated for the reference time, automatically releasing the corresponding session.

20. The method of claim 10, wherein the managing of the traffic includes:
when the aging policy is determined as APN unit/manual/reference time, checking whether a traffic is generated in a session set by the APN for a reference time;
when the traffic is not generated for the reference time, recording in subscriber information as a manual call connection; and
searching, by the manager, for a corresponding session using an aging object searching command to manually release the connection of the corresponding session.
